(19) United States
(12) Patent Application Publication
(10) Pub. No.: US 2026/0294127 A1
(43) Pub. Date: Oct. 1, 2026

(54) AIR MATTRESS

(71) Applicant: Paramount Bed Co., Ltd., Tokyo (JP)

(72) Inventors: Ryosuke YAHAGI, Koto-ku (JP); Kosuke TAKANO, Koto-ku (JP)

(73) Assignee: Paramount Bed Co., Ltd., Tokyo (JP)

(21) Appl. No.: 19/274,940

(22) Filed: Jul. 21, 2025

(30) Foreign Application Priority Data
Mar. 27, 2025 (JP) 2025-053720

(51) Int. Cl. A47C 27/08; A47C 27/00; A47C 31/12

(52) U.S. Cl. CPC A47C 27/083; A47C 27/001; A47C 27/082; A47C 31/123

(57) ABSTRACT

An air mattress includes: a plurality of air cells; and a controller configured to control an operation of an air blowing section configured to supply air to the plurality of air cells, the controller being configured to control internal pressure in the plurality of air cells. The controller is configured to determine position/posture of a user based on a detection value corresponding to a speed of the change in the internal pressure in the air cells when the controller changes the internal pressure in the air cells.

### CROSS-REFERENCE TO RELATED APPLICATIONS

This application is based upon and claims the benefit of priority from Japanese Patent Application No. 2025-053720, filed on Mar. 27, 2025; the entire contents of which are incorporated herein by reference.

### FIELD

An embodiment of the present disclosure relates to an air mattress.

### BACKGROUND

There is a technique in which a sensor provided to a bed determines the presence or absence of bed departure.

### BRIEF DESCRIPTION OF THE DRAWINGS

FIG. 1 is a side view illustrating a motorized bed unit provided with an air mattress according to an embodiment.

FIG. 2 is a block diagram illustrating a control system of the air mattress.

FIG. 3 is a schematic exploded diagram of the mattress.

FIG. 4 is a diagram illustrating an air supply/exhaust system of the air mattress.

FIG. 5 is a diagram illustrating the air supply/exhaust system of the air mattress.

FIG. 6 is a graph illustrating an example of an air-supply curve.

FIG. 7 is a graph illustrating an example of a measurement result of a difference of normalized air-supply time.

FIG. 8 is a graph illustrating an example of air-exhaust time.

FIG. 9 is a graph illustrating an example of an air-supply curve.

FIG. 10 is a graph illustrating an example of air-supply time.

FIG. 11 is a flowchart illustrating an example of determination of position/posture by a mattress controller.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is an air mattress including: a plurality of air cells; and a controller configured to control an operation of an air blowing section configured to supply air to the plurality of air cells, the controller being configured to control internal pressure in the plurality of air cells, in which the controller is configured to determine position/posture of a user based on a detection value corresponding to a speed of the change in the internal pressure in the air cells when the controller changes the internal pressure in the air cells.

Hereinafter, an embodiment of the present disclosure will be described with reference to the drawings.

In the description and the drawings, components similar to those described previously with reference to earlier drawings are denoted by the same reference numerals, and detailed descriptions thereof will be omitted as appropriate.

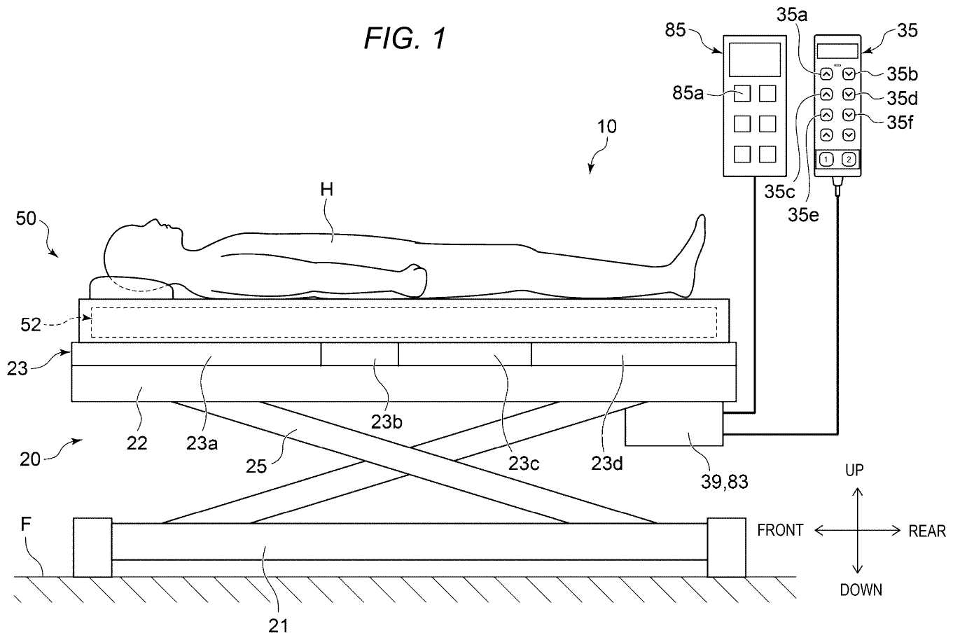

FIG. 1 is a side view illustrating a motorized bed unit provided with an air mattress according to an embodiment.

A motorized bed unit 10 illustrated in FIG. 1 is used in a care facility, a hospital, and a home, for example, and is configured to be able to electrically raise and tilt a backrest, an upper leg part, and the like, and be able to electrically change the height of a bed 20. The motorized bed unit 10 illustrated in FIG. 1 is illustrated in a simplified manner, in which illustration of drive devices for raising and tilting the backrest, the upper leg part, and the like, and changing the height of the bed 20 is omitted. In the embodiment, description will be made by indicating a head side and a foot side of a user H lying on the bed 20 as a front side and a rear side, respectively. The motorized bed unit 10 is provided with the bed 20, and an air mattress 50 provided to the bed 20.

The bed 20 includes a base frame 21 that is placed on a floor surface F, main frames 22 that are positioned above the base frame 21, and sections 23 that can be raised and tilted relative to the main frames 22. The two main frames 22 are provided apart from each other in a left-and-right direction (lateral direction) of the bed 20, and extend in a front-and-rear direction. The base frame 21 supports the main frames 22 via a lifting mechanism 25, for example.

The sections 23 include an upper surface, which is a placed surface of a mattress 52. As illustrated in FIG. 1, the sections 23 support the user H via the mattress 52. The sections 23 include a back section 23a, a seat section 23b, an upper leg section 23c, and a lower leg section 23d.

Below the sections 23, for example, a driving mechanism that drives the back section 23a, a driving mechanism that drives the upper leg section 23c and the lower leg section 23d, the lifting mechanism 25 that lifts up and lowers down the main frames 22 and the sections 23, and a bed controller 39 that controls an actuation of each mechanism, are provided. In each of the driving mechanisms and the lifting mechanism, a drive device including an electric cylinder is used.

A bed user interface device 35 is a remote controller for operating each drive device. The bed user interface device 35 is connected to the bed controller 39 in a wired or wireless manner. The user H and a care giver can raise and tilt the back section 23a, the upper leg section 23c, and the lower leg section 23d, and change the height of the bed 20 from the floor surface F, by operating operation buttons of the bed user interface device 35.

The bed user interface device 35 includes, for example, a back raising button 35a, a back lowering button 35b, a leg raising button 35c, a leg lowering button 35d, an ascending button 35e, and a descending button 35f. The back raising button 35a and the back lowering button 35b are for actuating the drive device that drives the back section 23a. The leg raising button 35c and the leg lowering button 35d are for actuating the drive device that drives the upper leg section 23c and the lower leg section 23d. The ascending button 35e and the descending button 35f are for actuating the drive device that lifts up and lowers down the main frame 22 and the sections 23.

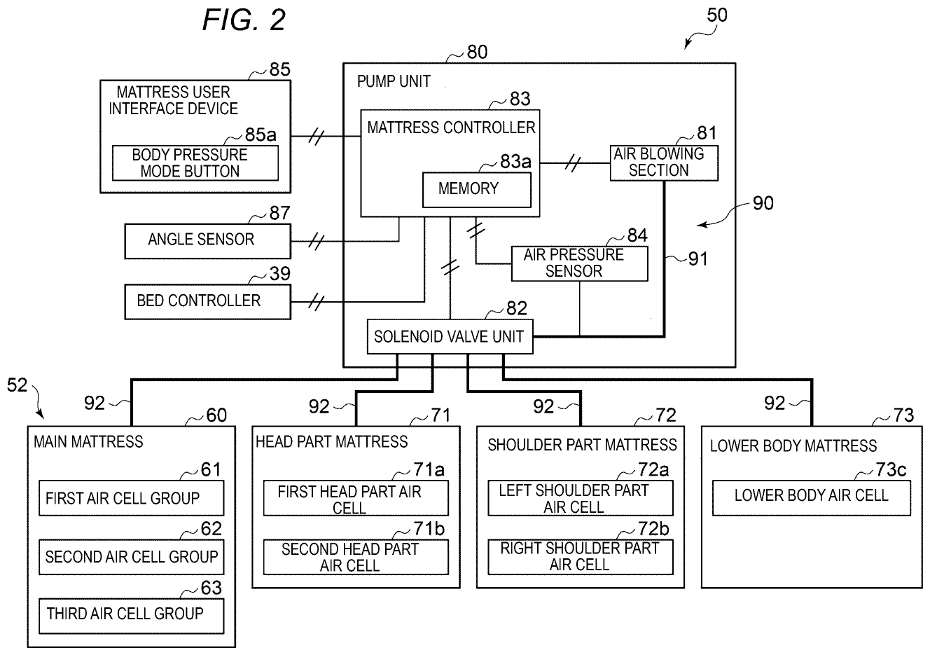

An angle sensor 87 (see FIG. 2) detects an inclined angle (back angle) of the back section 23a with respect to the horizontal direction. The angle sensor 87 detects, for example, a raising/tilting angle of the back section 23a with respect to the seat section 23b. The angle sensor 87 may detect an inclined angle of the back section 23a with respect to the horizontal direction when the sections 23 of the bed 20 are tilted upward, for example. The angle sensor 87 transmits the detected detection result to a mattress controller 83, for example.

The bed controller 39 includes, for example, a control circuit that controls the drive devices. The bed controller 39 is provided below the sections 23, for example. The bed controller 39 is connected to the bed user interface device 35. The bed controller 39 controls actuations of the drive devices based on the operation of the bed user interface device 35.

The bed controller 39 includes a memory. The memory may be an arbitrary storage device, such as a ROM or a RAM. Programs for actuating the respective drive devices are stored in the memory. The bed controller 39 actuates the respective drive devices based on a command signal transmitted from the bed user interface device 35. The bed controller 39 transmits a command signal toward the mattress controller 83. For example, the bed controller 39 may transmit a command signal toward the mattress controller 83, based on a detection result of a back angle detected by an actuator and the like in the bed, for example.

FIG. 2 is a block diagram illustrating a control system of the air mattress.

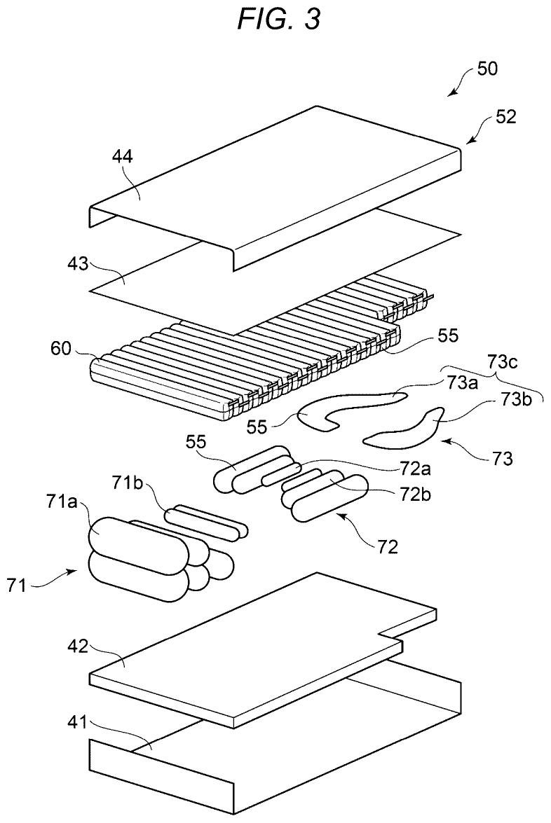

FIG. 3 is a schematic exploded diagram of the mattress.

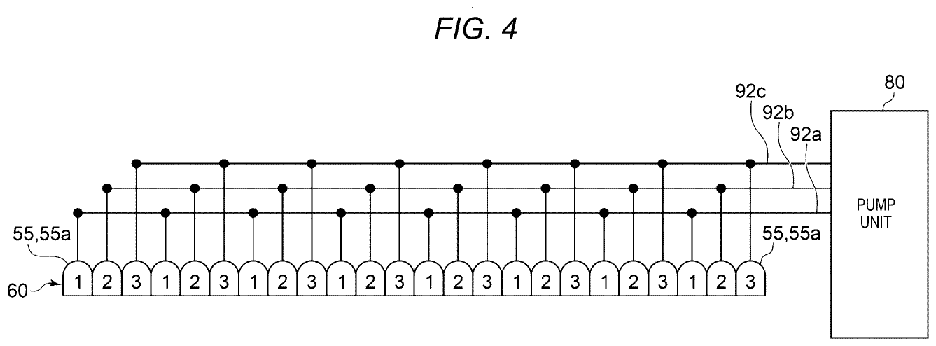

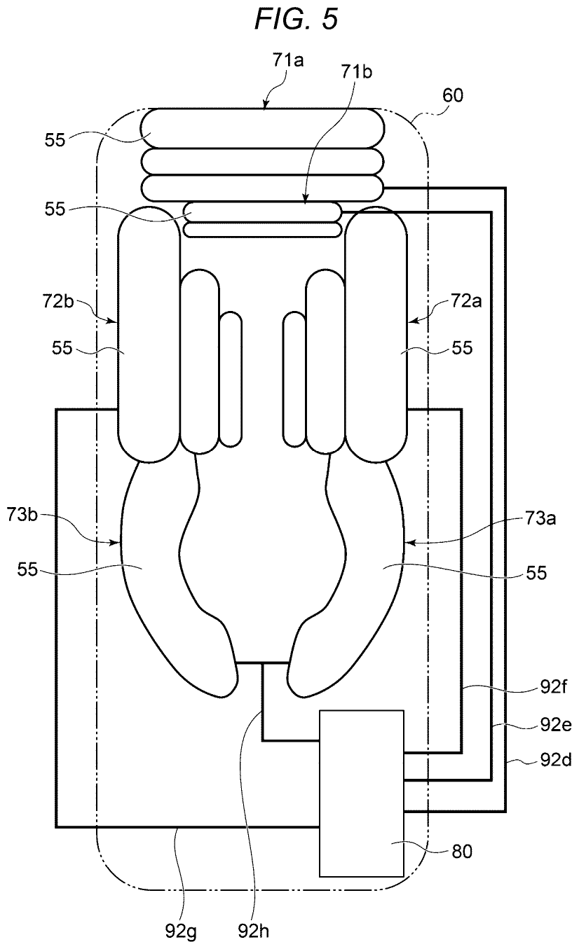

FIGS. 4 and 5 are diagrams illustrating an air supply/exhaust system of the air mattress.

As illustrated in FIG. 2, the air mattress 50 is provided with the mattress 52 that supports the user H, the mattress controller 83, and a mattress user interface device 85. As illustrated in FIG. 3, the mattress 52 includes a plurality of air cells 55.

In the air mattress 50, the internal pressure in the plurality of air cells 55 is controlled to allow the mattress 52 to have a preferred hardness of the user H. In this example, a case where the bed 20 is provided with the air mattress 50 is described as an example. However, the air mattress 50 in which the mattress 52 is directly placed on the floor surface F may be used.

As illustrated in FIG. 3, in this example, the mattress 52 has a structure in which a sections cover 41, an elastic member 42 (bottom urethane), a sub mattress (a head part mattress 71, a shoulder part mattress 72, and a lower body mattress 73), a main mattress 60, an elastic member 43 (top urethane), and a top cover 44 are laminated in this order from the bottom.

For example, the main mattress 60 is used in a case where body pressure of the user H is dispersed in a body pressure mode, which is described later. As illustrated in FIG. 4, the main mattress 60 includes, as the plurality of air cells 55, a plurality of air cells 55a arranged in the front-and-rear direction. One air cell 55a extends in accordance with the left-and-right direction (width direction) of the sections 23, for example. In this example, 24 pieces of the air cells 55a are arranged in the front-and-rear direction. The plurality of air cells 55a are classified into three systems of a first air cell group 61, a second air cell group 62, and a third air cell group 63.

The air cells 55a denoted by “1” indicate the first air cell group 61. The air cells 55a denoted by “2” indicate the second air cell group 62. The air cells 55a denoted by “3” indicate the third air cell group 63. The air cells 55a for each group have the same air supply/exhaust system. In other words, the similar internal pressure control is executed in the air cells 55a denoted by the same number.

In this example, the air cells 55a of the main mattress 60 are arranged from the front side (head side) in the order of “1”, “2”, “3”, “1” . . . , but the order of the air cells 55a of the main mattress 60 is not limited thereto. The air cells 55a in which air supply/exhaust is executed together are arbitrary arranged, and are not necessarily arranged in a regular order. For example, the main mattress 60 is classified into the respective air cell groups so as to disperse the comfortableness of the user H and the body pressure of the user H with high efficiency. In this example, the air cells 55a are classified into three groups, but may be classified into two groups or four or more groups.

The head part mattress 71 is positioned below the main mattress 60. The head part mattress 71 is positioned on the back section 23a in a state where the mattress 52 is placed above the sections 23. The head part mattress 71 includes a first head part air cell 71a and a second head part air cell 71b, as the plurality of air cells 55. In this example, each of the first head part air cell 71a and the second head part air cell 71b is an air cell group including a plurality of air cells 55. The first head part air cell 71a is positioned below an occipital region of the user H who takes a supine position. The first head part air cell 71a inflates to cause a cervical region of the user H to bend forward. The second head part air cell 71b is disposed on the foot side of the first head part air cell 71a. The second head part air cell 71b is positioned below a chest of the user H who takes a supine position. The second head part air cell 71b inflates to push the chest of the user H upward. The head part mattress 71 has an air cell shape that can further increase an angle by about 20 degrees from an inclined angle of the back section 23a in the bed 20, from the chest over the occipital region of the user H, for example. Accordingly, the head part mattress 71 can easily cause the user H to take a swallowing posture, which is demanded in a meal care cite and the like.

The shoulder part mattress 72 is positioned below the main mattress 60. The shoulder part mattress 72 is positioned below from the shoulder part to the seat part of the user H who takes a supine position on the main mattress 60. The shoulder part mattress 72 is positioned on the back section 23a in a state where the mattress 52 is placed above the sections 23. The shoulder part mattress 72 inflates or deflates, for example, when the back section 23a in the bed 20 is raised and tilted, and is standing. Accordingly, the shoulder part mattress 72 adjusts a position of the user H on the main mattress 60, or changes a body position of the user H. The shoulder part mattress 72 includes a left shoulder part air cell 72a and a right shoulder part air cell 72b, as the plurality of air cells 55. The left shoulder part air cell 72a is positioned below a left upper body of the user H who takes a supine position. The right shoulder part air cell 72b is positioned below a right upper body of the user H who takes a supine position. In this example, each of the left shoulder part air cell 72a and the right shoulder part air cell 72b is an air cell group including a plurality of air cells 55 that extends in the front-and-rear direction and is arranged in the left-and-right direction.

The lower body mattress 73 is positioned below the main mattress 60. The lower body mattress 73 includes a lower body air cell 73c. The lower body air cell 73c is an air cell group including a left lower body air cell 73a and a right lower body air cell 73b, as the plurality of air cells 55. The left lower body air cell 73a is disposed so as to be positioned below the left lower body of the user H. The right lower body air cell 73b is disposed so as to be positioned below the right lower body of the user H. The left lower body air cell 73a and the right lower body air cell 73b are formed in curved shapes respectively protruding outward in the left-and-right direction. In a case where the left lower body air cell 73a and the right lower body air cell 73b inflate, a space is formed between the left lower body air cell 73a and the right lower body air cell 73b. Buttocks of the user H are configured to position within the space. The lower body mattress 73 has a shape that wraps the buttocks of the user H, and eases an increase in the body pressure around the buttocks, which results in an increase in a bedsore risk, in a case where the back section 23a is back-raised. The lower body mattress 73 can prevent the user H from shifting to the foot side in a case where the back section 23a is back-raised, and cause the user H to take a stable posture.

The air supply/exhaust system of the first air cell group 61, the air supply/exhaust system of the second air cell group 62, the air supply/exhaust system of the third air cell group 63, the air supply/exhaust system of the first head part air cell 71a, the air supply/exhaust system of the second head part air cell 71b, the air supply/exhaust system of the left shoulder part air cell 72a, the air supply/exhaust system of the right shoulder part air cell 72b, and the air supply/exhaust system of the lower body air cell 73c may be air supply/exhaust systems different from one another. The internal pressure control different from one another can be independently made with respect to the air cells 55 having air supply/exhaust systems different from one another.

The arrangement of the head part mattress 71, the shoulder part mattress 72, and the lower body mattress 73 is not limited to the abovementioned example, but may be provided above or lateral to the main mattress 60, for example, or may be independent of the main mattress 60.

A pump unit 80 is mounted below the sections 23 of the bed 20, for example. The pump unit 80 controls the hardness of each air cell 55 by supplying and exhausting the air to and from each air cell 55 of the air mattress 50. As illustrated in FIG. 2, the pump unit 80 includes an air blowing section 81, a solenoid valve unit 82, the mattress controller 83, and an air pressure sensor 84.

In the air mattress 50, a flow path 90 (pipeline) that connects the air blowing section 81 to the plurality of air cells 55 is provided. As illustrated in FIG. 2, the flow path 90 includes a first flow path part 91 and a second flow path part 92. The first flow path part 91 is connected to the air blowing section 81. The first flow path part 91 establishes a connection between the air blowing section 81 and a solenoid valve in the solenoid valve unit 82.

The second flow path part 92 connects the air cells 55 to the first flow path part 91. The second flow path part 92 establishes a connection between the air cells 55 and the solenoid valve in the solenoid valve unit 82. A plurality of the second flow path parts 92 is provided so as to correspond to the plurality of air supply/exhaust systems. Each second flow path part 92 supplies the air sent from the air blowing section 81 via the first flow path part 91 and the solenoid valve unit 82 to the air cell group to which each second flow path part 92 is connected. In FIG. 2, for convenience, the second flow path part 92 is collectively illustrated for each mattress in a simplified manner.

More specifically, as illustrated in FIG. 4, as the plurality of second flow path parts 92, second flow path parts 92a, 92b, and 92c are provided. The second flow path parts 92a, 92b, and 92c are respectively connected to the first air cell group 61, the second air cell group 62, and the third air cell group 63. As illustrated in FIG. 5, as the plurality of second flow path parts 92, second flow path parts 92d, 92e, 92f, 92g, and 92h are provided. The second flow path parts 92d, 92e, 92f, 92g, 92h are respectively connected to the first head part air cell 71a, the second head part air cell 71b, the left shoulder part air cell 72a, the right shoulder part air cell 72b, and the lower body air cell 73c (the left lower body air cell 73a and the right lower body air cell 73b).

In this example, the air is supplied and exhausted to and from the left lower body air cell 73a and the right lower body air cell 73b, as the common air supply/exhaust system. The left lower body air cell 73a and the right lower body air cell 73b may be configured as separate air supply/exhaust systems.

The air blowing section 81 supplies the air to the main mattress 60, the head part mattress 71, the shoulder part mattress 72, and the lower body mattress 73, via the flow path 90. Specifically, the air blowing section 81 supplies the air to each air cell group (each of the first air cell group 61, the second air cell group 62, the third air cell group 63, the first head part air cell 71a, the second head part air cell 71b, the left shoulder part air cell 72a, the right shoulder part air cell 72b, and the lower body air cell 73c), via the solenoid valve unit 82. The air blowing section 81 is an electric air pump (pump main body). The mattress controller 83 controls an operation of the air blowing section 81.

The solenoid valve unit 82 is positioned between the air cells 55 (the air cells 55 of each of the main mattress 60, the head part mattress 71, the shoulder part mattress 72, and the lower body mattress 73) and the air blowing section 81. The solenoid valve unit 82 includes a plurality of solenoid valves provided to the flow path 90. The solenoid valve unit 82 may include a manifold.

For example, each solenoid valve is provided so as to correspond to each of the first air cell group 61, the second air cell group 62, the third air cell group 63, the first head part air cell 71a, the second head part air cell 71b, the left shoulder part air cell 72a, the right shoulder part air cell 72b, and the lower body air cell 73c. In other words, the same solenoid valve is used for the air cells 55 that are commonly controlled.

The solenoid valve unit 82 includes an exhaust valve (not illustrated) that exhausts the air in each air cell 55 to the outside. The exhaust valve is connected to the flow path 90 on a first flow path part 91 side from the solenoid valve. When the exhaust valve is opened, the first flow path part 91 communicates with the outside to allow the air to be discharged from the first flow path part 91 to the outside. When the exhaust valve is closed, the first flow path part 91 is cut off from the outside. It is also possible to provide another exhaust valve on the air blowing section 81 side, different from the flow path 90, and exhaust the air sucked from the air cell group by reversely operating the air blowing section, from another valve.

Each of the plurality of solenoid valves in the solenoid valve unit 82 opens and closes between the first flow path part 91 and each of the second flow path parts 92. Opening the solenoid valve indicates opening between the first flow path part 91 and the second flow path part 92, in other words, causing the first flow path part 91 and the second flow path part 92 to communicate with each other. When the air blowing section 81 actuates in a state where the first flow path part 91 and the second flow path part 92 communicate with each other, the air from the air blowing section 81 is supplied to the air cells 55 connected to the relevant second flow path part 92. When the air blowing section 81 stops and the exhaust valve of the flow path 90 opens in a state where the first flow path part 91 and the second flow path part 92 communicate with each other, the air in the air cells 55 connected to the relevant second flow path part 92 is exhausted. Closing the solenoid valve indicates closing between the first flow path part 91 and the second flow path part 92, in other words, cutting off the air flow between the first flow path part 91 and the second flow path part 92.

A solenoid valve can be used as the exhaust valve. However, in the description of the embodiment, the solenoid valve simply referred indicates the solenoid valve (valve that opens and closes between the first flow path part 91 and each second flow path part 92) other than the exhaust valve.

The mattress controller 83 is, for example, a calculation circuit including a CPU and the like. The mattress controller 83 includes a control circuit that controls operations of the air blowing section 81 and the solenoid valve unit 82. The mattress controller 83 controls opening and closing operations of each solenoid valve and the exhaust valve. In other words, the mattress controller 83 controls the solenoid valve unit 82 to switch communicating-with/cutting-off between the selected second flow path part 92, among the plurality of second flow path parts 92, and the first flow path part 91. The mattress controller 83 opens and closes the solenoid valve to switch communicating-with/cutting-off between the air blowing section 81 and each air cell group. The mattress controller 83 selectively controls air-supply and air-exhausting of the plurality of air cell groups.

In this manner, the mattress controller 83 changes the internal pressure in each air cell group. Accordingly, the mattress controller 83 controls the hardness of the mattress 52. The mattress controller 83 includes a memory 83a in which a control program for controlling the internal pressure in each air cell group is stored. The memory 83a may be an arbitrary storage device, such as a ROM or a RAM.

The mattress controller 83 is connected to the mattress user interface device 85, which is described later, and controls the actuation of the air blowing section 81 and the opening and closing operation of the solenoid valve unit 82 based on a command signal from the mattress user interface device 85. For example, a control program based on a command signal from the mattress user interface device 85 is stored in the memory 83a.

The mattress controller 83 controls the actuation of the air blowing section 81 and the opening and closing operation of the solenoid valve unit 82 based on a command signal transmitted from the bed controller 39. For example, a control program based on a command signal from the bed controller 39 is stored in the memory 83a. The mattress controller 83 may be able to control the air cells 55 based on back angle information on the bed acquired by an angle sensor provided to the mattress itself, and the like, without communicating with the bed. The mattress controller 83 decreases the internal pressure in the air cells 55 of the main mattress 60 or increases the internal pressure in at least any of the head part mattress, the shoulder part mattress, and the lower body mattress, in a case where the angle sensor 87 or the like has detected the back angle equal to or larger than a predetermined angle, for example.

The air pressure sensor 84 measures internal pressure in the first flow path part 91. In other words, the air pressure sensor 84 measures internal pressure in the flow path 90 on a side closer to the air blowing section 81 than the solenoid valve. The internal pressure in the first flow path part 91 to be measured by the air pressure sensor 84 may be internal pressure in the manifold of the solenoid valve unit 82 (for example, internal pressure in a tube connected to the manifold). In other words, the first flow path part 91 may include a part of the manifold of the solenoid valve unit 82.

The air pressure sensor 84 detects internal pressure in the first flow path part 91 in a state where the first flow path part 91 and the second flow path part 92 communicate with each other, thereby detecting internal pressure in the air cell group connected to the relevant second flow path part 92.

The mattress controller 83 acquires a detection value by the air pressure sensor 84. The mattress controller 83 controls, based on the detection value by the air pressure sensor 84, the actuation of the air blowing section 81 and the opening and closing operations of the respective solenoid valves in the solenoid valve unit 82.

The mattress controller 83 includes a body pressure mode in which the body pressure of the user H on the mattress 52 is dispersed. A control program for the body pressure mode is stored in the memory 83a. In this example, the bed controller 39 and the mattress controller 83 have been described as separate controllers but are not limited thereto, and the bed controller 39 and the mattress controller 83 may be configured as one controller. The bed controller 39 and the mattress controller 83 can be integrally or dispersedly provided as appropriate.

The mattress user interface device 85 is a remote controller that is operated in order to change the internal pressure in the plurality of air cells 55. The mattress user interface device 85 is connected to the mattress controller 83 in a wired or wireless manner. The user H and a care giver can change the internal pressure (hardness) in each air cell group by operating the mattress user interface device 85.

The mattress user interface device 85 includes a body pressure mode button 85a that is operated for causing the mattress controller 83 to execute the body pressure mode. Each operation button may be a press button, or may be a touch panel or the like.

In a case where the body pressure mode button 85a of the mattress user interface device 85 is operated, the mattress controller 83 executes the air supply/exhaust control of the first air cell group 61 to the third air cell group 63, based on the control program for the body pressure mode stored in the memory 83a.

For example, the mattress controller 83 acquires a back angle detected by the angle sensor 87. In the main mattress 60, the back section 23a in the bed 20 is back-raised to increase the back angle.

When the detection value by the angle sensor 87 has become equal to or larger than an angle threshold, the mattress controller 83 starts the actuation of the air blowing section 81 and causes the solenoid valve unit 82 to be in an open state to start air-supply to the lower body mattress 73. The angle threshold is set to a value equal to or greater than 20 degrees and equal to or less than 35 degrees (for example, 30 degrees), and is stored in the memory 83a.

The mattress controller 83 continues the air-supply to the lower body mattress 73 until the air pressure sensor 84 detects predetermined internal pressure. The predetermined internal pressure is, for example, internal pressure when the lower body mattress 73 fully inflates.

Accordingly, the lower body mattress 73 can ease an increase in body pressure around the buttocks, which results in an increase in a bedsore risk, and prevent the user H from shifting to the foot side to cause the user H to take a stable posture.

Next, in a case where the lower body mattress 73 has inflated to the predetermined internal pressure, the mattress controller 83 switches the solenoid valve unit 82 to start the air-supply to the head part mattress 71. The mattress controller 83 continues the air-supply to the head part mattress 71 until the air pressure sensor 84 detects the predetermined internal pressure. The predetermined internal pressure is, for example, internal pressure when the head part mattress 71 fully inflates. Accordingly, the head part mattress 71 can easily cause the user H to take a swallowing posture, which is demanded in a meal care cite and the like.

Next, in a case where the head part mattress 71 has inflated to the predetermined internal pressure, the mattress controller 83 switches the solenoid valve unit 82 to start the air-supply to the shoulder part mattress 72. The mattress controller 83 continues the air-supply to the shoulder part mattress 72 until the air pressure sensor 84 detects the predetermined internal pressure. The predetermined internal pressure is, for example, internal pressure (pressure threshold) when the shoulder part mattress 72 fully inflates.

In a case where the back section 23a is back-raised, the user H has a high position of the center of gravity, so that a posture of the user H becomes unstable. The shoulder part mattress 72 lifts up outer sides in the lateral direction of the main mattress 60, and thus can make the posture of the user H stable.

In the above, the example in a case where the lower body mattress 73, the head part mattress 71, and the shoulder part mattress 72 are caused to inflate in this order has been described. However, the aspect of the disclosure is not limited thereto, but, for example, the air may be supplied simultaneously to two or more mattresses, or the air may be supplied simultaneously to three or more mattresses. The order of suppling the air to the mattresses may be switched as appropriate.

In the mattress user interface device 85, operation buttons that each cause the mattress controller 83 to perform the air supply/exhaust control of each of the head part mattress 71, the shoulder part mattress 72, and the lower body mattress 73 may be provided. The angle sensor 87 may be provided to the mattress 52 (for example, the main mattress 60), or may detect an inclined angle (back angle) of the main mattress 60 with respect to the horizontal direction.

The mattress controller 83 can further execute determination control that determines (estimates) position/posture of a user present on the mattress 52. The position/posture is at least either of a position and a posture. The determination of a position is determining that the user is positioned on the center or edge of the mattress 52, for example. The determination of a posture is determining that the user is in a supine position, a long sitting position, or an edge sitting position, for example.

In such determination control, the mattress controller 83 controls the air blowing section 81 and the solenoid valve unit 82 to change internal pressure in a first air cell (for example, the left shoulder part air cell 72a) and a second air cell (for example, the right shoulder part air cell 72b). The second air cell is arranged with the first air cell in a direction intersecting with the up-and-down direction. For example, the left shoulder part air cell 72a is arranged with the right shoulder part air cell 72b in the left-and-right direction. The air supply/exhaust system of the second air cell is different from the air supply/exhaust system of the first air cell.

When changing internal pressure in the first air cell, the mattress controller 83 detects a first detection value corresponding to a speed of the change in the internal pressure in the first air cell based on the internal pressure in the first air cell successively measured by the air pressure sensor 84. Similarly, when changing internal pressure in the second air cell, the mattress controller 83 detects a second detection value corresponding to a speed of the change in the internal pressure in the second air cell based on the internal pressure in the second air cell successively measured by the air pressure sensor 84. The mattress controller 83 determines position/posture of the user based on a comparison between the first detection value and the second detection value.

More specifically, the detection values to be compared in the determination control of position/posture are based on the detection air-supply time in the respective air cells. In the specification of the present application, “detection air-supply time” indicates time from when air-supply is started to an air cell in an air-exhausted state to when internal pressure in the air cell reaches a predetermined value (for example, predetermined pressure P1). The mattress controller 83 measures a detection air-supply time of each air cell. The mattress controller 83 calculates a first detection value based on detection air-supply time of the first air cell (time from when air-supply is started to the first air cell in an air-exhausted state to when internal pressure in the first air cell reaches a first predetermined value), and calculates a second detection value based on detection air-supply time of the second air cell (time from when air-supply is started to the second air cell in an air-exhausted state to when internal pressure in the second air cell reaches a second predetermined value). The predetermined value (predetermined pressure) for detecting a detection air-supply time may be a value (for example, the predetermined pressure P1) common to the plurality of air cells, or may be set such that each air cell has a different value. In other words, for example, the second predetermined value may be the same as or different from the first predetermined value.

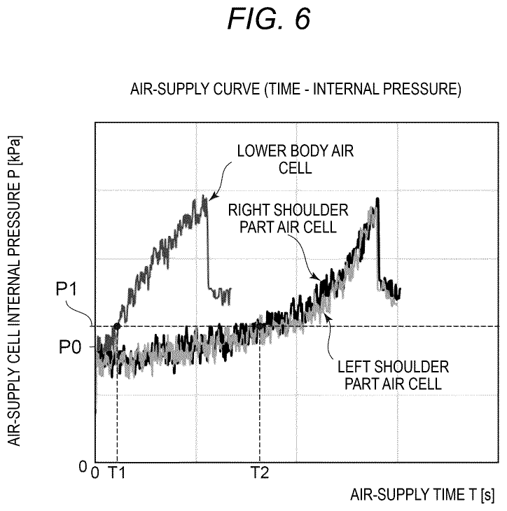

FIG. 6 is a graph illustrating an example of an air-supply curve.

The air-supply curve indicates a relation between time T when air-supply is performed and internal pressure P in the air cells. At 0 second on the horizontal axis, each air cell is in an air-exhausted state. The air-exhausted state is a state where the air in the air cell is exhausted with the exhaust valve of the pump unit 80, and the internal pressure has decreased, and a state where the air cell deflates. The air-exhausted state is, for example, a state where the internal pressure in the air cell is equal to or less than predetermined pressure P0. The predetermined pressure P0 may be, for example, equal to or greater than 0 kPa and equal to or less than 0.9 kPa. The predetermined pressure P0 may also be equal to or less than 0 kPa. In this example, the detection air-supply time is time until the internal pressure in the air cell in an air-exhausted state reaches 1 kPa. In the example in FIG. 6, the detection air-supply time of the lower body air cell 73c is T1. The detection air-supply time of the left shoulder part air cell 72a and the detection air-supply time of the right shoulder part air cell 72b are T2. The detection air-supply time may be, for example, time taken until the internal pressure in the air cell reaches the predetermined pressure P1 from the predetermined pressure P0. Although the air-supply start in each air cell is uniformly illustrated at 0 seconds on the horizontal axis in FIG. 6, the air may be actually supplied to each air cell at different timing.

The measurement of detection air-supply time is performed, for example, in a state where the sections 23 on the bed 20 are flat, in other words, in a state where the back section 23a, the seat section 23b, the upper leg section 23c, and the lower leg section 23d are not inclined to the horizontal direction. In the measurement of detection air-supply time, the internal pressure in the air cells 55 on the main mattress 60 is held constant and does not change. In the measurement of detection air-supply time, the mattress controller 83 performs the air-supply by causing the air blowing section 81 to operate in a state where the solenoid valve is open for each air cell, for example. In the measurement of detection air-supply time for a plurality of air cells, output of the air blowing section 81 may be common predetermined output.

For example, the first detection value is a value obtained by normalizing the measured detection air-supply time of the first air cell with first reference time. In other words, for example, the first detection value is a ratio of a measurement value of the detection air-supply time of the first air cell with respect to the first reference time. The first reference time is detection air-supply time of the first air cell measured in a state where no user is present on the mattress 52.

Similarly, the second detection value is a value obtained by normalizing the measured detection air-supply time of the second air cell with second reference time. In other words, for example, the second detection value is a ratio of a measurement value of the detection air-supply time of the second air cell with respect to the second reference time. The second reference time is detection air-supply time of the second air cell measured in a state where no user is present on the mattress 52. The first reference time and the second reference time may be acquired in advance, and be stored in the memory 83a.

The mattress controller 83 calculates a first evaluation value indicating a difference between the first detection value and the second detection value. In this example, the first evaluation value is a difference between the first detection value and the second detection value. The mattress controller 83 determines position/posture of the user based on the first evaluation value.

In each air cell, the detection value (in this example, the normalized detection air-supply time) changes depending on a load by the body weight of the user. For example, in the air cell to which the body weight of user is applied more, the detection air-supply time becomes shorter. In this case, the position/posture of the user can be determined as the position/posture in which the body weight is applied more to the cell with the short detection air-supply time than the cell with the long detection air-supply time. For example, the position of the user is closer to the cell with the short normalized detection air-supply time than the cell with the long normalized detection air-supply time. The evaluation value (in this example, the difference of the normalized detection air-supply time) is a value that reflects to which air cell the load by the body weight of the user is applied more. The position/posture of the user can be determined based on the first evaluation value.

For example, in the mattress, a relation between the evaluation value and the position/posture may be acquired in advance by the actual measurement. A relation, acquired in advance, between the evaluation value and the position/posture (or a determination condition of position/posture by an evaluation value determined based on the relation, or the like) may be stored in the memory 83a or the like, and position/posture of the user may be determined based on the relation (or the determination condition), and an evaluation value measured this time.

For example, in order to detect position/posture of the user present on the air mattress, it can be considered that a pressure sensor of a capacitance type or the like is provided to the air mattress. On the other hand, in the embodiment, because the air cell that can be used for stabilizing the posture of the user can also be used for determining position/posture of the user, no pressure sensor needs to be separately provided.

For example, after the determination of position/posture of the user, the mattress controller 83 controls the internal pressure in the air cell 55 in the main mattress 60 in accordance with the determination result. For example, the mattress controller 83 sets the internal pressure in the air cell 55 in the main mattress 60 when determining a long sitting position or an edge sitting position higher than that when determining a supine position. This can prevent bottoming in the long sitting position or the edge sitting position.

In the determination of position/posture, the third air cell (for example, the lower body air cell 73c) may be used. The air supply/exhaust system of the third air cell is different from the air supply/exhaust system of the first air cell and the air supply/exhaust system of the second air cell. The third air cell is arranged with the first air cell and the second air cell in the second direction. For example, the lower body air cell 73c is arranged with the left shoulder part air cell 72a and the right shoulder part air cell 72b in the front-and-rear direction. The second direction is a direction intersecting with the up-and-down direction and intersecting with the first direction. The first direction is a direction along which the first air cell and the second air cell are arranged.

The mattress controller 83 detects a third detection value of the third air cell, similar to the first and second detection values of the first and second air cells. That is as follows.

When changing internal pressure in the third air cell, the mattress controller 83 detects a third detection value corresponding to a speed of the change in the internal pressure in the third air cell based on the internal pressure in the third air cell successively measured by the air pressure sensor 84. For example, the mattress controller 83 calculates a third detection value based on detection air-supply time of the third air cell. For example, the third detection value is a value obtained by normalizing the measured detection air-supply time of the third air cell (time from when air-supply is started to the third air cell in an air-exhausted state to when the internal pressure in the third air cell reaches a third predetermined value), with third reference time. The third reference time is detection air-supply time of the third air cell measured in a state where no user is present on the mattress 52. The third reference time may be acquired in advance, and be stored in the memory 83a.

The mattress controller 83 determines position/posture of the user based on a comparison between the first detection value and the third detection value. In other words, for example, the mattress controller 83 calculates a second evaluation value indicating a difference between the first detection value and the third detection value. In this example, the second evaluation value is a difference between the first detection value and the third detection value. The mattress controller 83 determines position/posture of the user based on the first evaluation value and the second evaluation value. Similarly, the determination of position/posture of the user may be based on a comparison between the second detection value and the third detection value.

In this manner, the mattress controller 83 determines position/posture of the user from the balance of the air-supply time with respect to the three air cells. The position/posture of the user can be determined more accurately by using the three air cells. The number of air cells to be used for the determination of position/posture may be two or three, or four or more air cells having different air supply/exhaust systems may be used. For example, based on a change in internal pressure in one air cell (for example, the length of the detection air-supply time), a position of a user, whether the user is close or apart to and from the air cell, can also be determined.

In the above, the example in a case where the first, second, and third air cells are respectively the left shoulder part air cell 72a, the right shoulder part air cell 72b, and the lower body air cell 73c has been indicated, but is not limited thereto.

For example, the second air cell may be the lower body air cell 73c, and the third air cell may be the right shoulder part air cell 72b. For example, the first air cell may be the right shoulder part air cell 72b, the second air cell may be one of the left shoulder part air cell 72a and the lower body air cell 73c, and the second air cell may be the other of the left shoulder part air cell 72a and the lower body air cell 73c. For example, the first air cell may be the lower body air cell 73c, the second air cell may be one of the left shoulder part air cell 72a and the right shoulder part air cell 72b, and the third air cell may be the other of the left shoulder part air cell 72a and the right shoulder part air cell 72b.

FIG. 7 is a graph illustrating an example of a measurement result of a difference of normalized air-supply time.

The first evaluation value on the longitudinal axis (left-right difference) is an absolute value of a difference between the normalized detection air-supply time of the left shoulder part air cell 72a and the normalized detection air-supply time of the right shoulder part air cell 72b. The second evaluation value on the horizontal axis (front-rear difference) is an absolute value of a difference between an average value of the normalized detection air-supply time of the left shoulder part air cell 72a and the normalized detection air-supply time of the right shoulder part air cell 72b, and the normalized detection air-supply time of the lower body air cell 73c.

FIG. 7 is a measurement result in a case where the users are a male having a body weight of 50 kg, a male having a body weight of 60 kg, a male having a body weight of 70 kg, and a doll having a weight of 20 kg.

In a case where the users are in a supine position, the first evaluation value (left-right difference) has a tendency to be smaller than a line L1 in FIG. 7. In a case where the users are in a long sitting position or an edge sitting position, the first evaluation value (left-right difference) has a tendency to be larger than the line L1 in FIG. 7.

For example, the mattress controller 83 may determine that the user is in the supine position if the left-right difference is smaller than the line L1 (a value determined based on the front-rear difference), and may determine that the user is in the long sitting position (or edge sitting position) if the left-right difference is larger than the line L1.

Alternatively, the mattress controller 83 may determine that the user is in the supine position if the left-right difference is smaller than a predetermined value, and may determine that the user is in the long sitting position (or edge sitting position) if the left-right difference is larger than the predetermined value.

In this manner, the mattress controller 83 determines that the user is in the supine position, the long sitting position, or the edge sitting position, for example, based on the first evaluation value (difference between the first detection value and the second detection value), and the second evaluation value (difference between the first detection value and the third detection value).

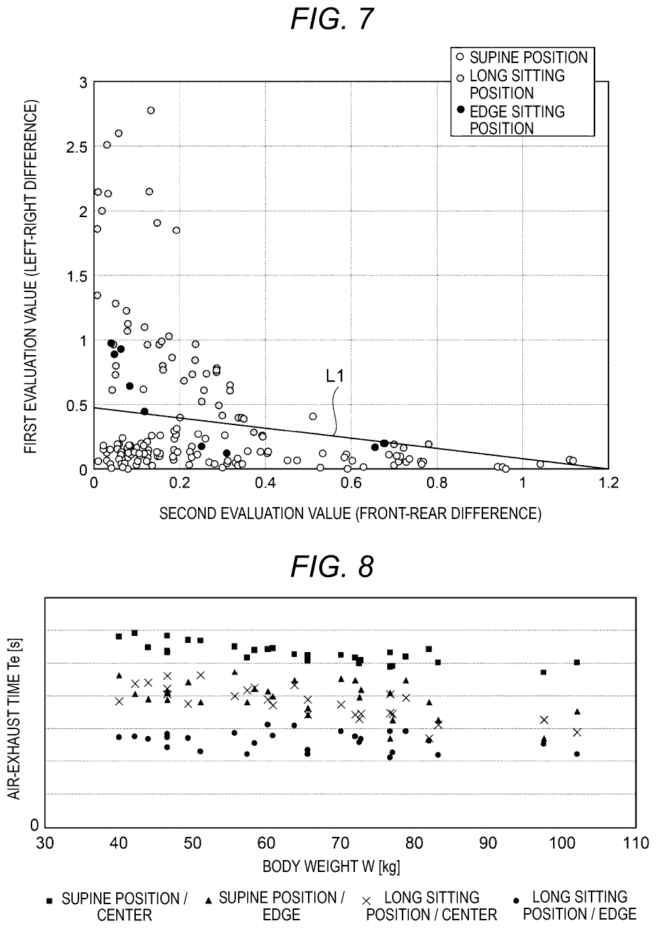

FIG. 8 is a graph illustrating an example of air-exhaust time.

When the mattress controller 83 opens the exhaust valve to exhaust the air in the air cell, air-exhaust time Te is time during when the internal pressure in the air cell decreases from first predetermined pressure to second predetermined pressure. The air-exhaust time illustrated in FIG. 8 is time during when the internal pressure in the lower body air cell 73c changes from predetermined start pressure corresponding to the internal pressure in actual use to predetermined air-exhausted state (for example, 0.5 kPa).

“SUPINE POSITION/CENTER” indicates a case where the user in the supine position is present on the center in the left-and-right direction of the mattress, “SUPINE POSITION/EDGE” indicates a case where the user in the supine position is present on the edge in the left-and-right direction of the mattress, “LONG SITTING POSITION/CENTER” indicates a case where the user in the long sitting position is present on the center in the left-and-right direction of the mattress, and “LONG SITTING POSITION/EDGE” indicates a case where the user in the long sitting position is present on the edge in the left-and-right direction of the mattress. In FIG. 8, the users are 28 persons each having a body weight W of from 40 kg to 100 kg.

In comparison between the plot of “SUPINE POSITION/CENTER” and the plot of “LONG SITTING POSITION/CENTER”, it is understood that the plot of “LONG SITTING POSITION/CENTER” has shorter air-exhaust time. A difference between the air-exhaust time in a case where the user is present on the edge of the mattress and the air-exhaust time in a case where the user is present on the center of the mattress can be seen, meanwhile a change due to the posture tends to be small. If it is known whether the position of a user when the plotted data is measured is on the center or the edge of the mattress, a posture of the user can be determined.

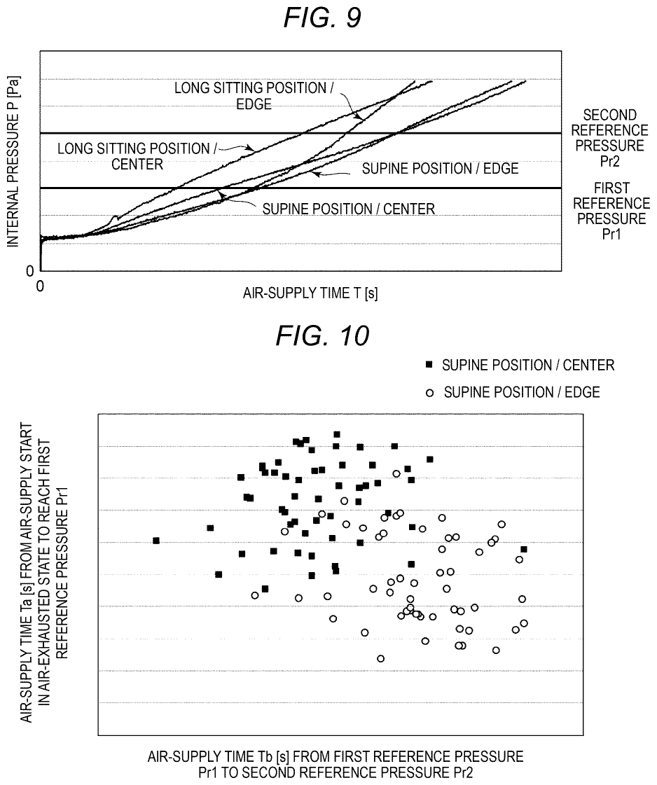

FIG. 9 is a graph illustrating an example of an air-supply curve.

The air-supply curve indicates a time change in internal pressure in the air cell when the mattress controller 83 supplies the air to an air cell. FIG. 9 is an air-supply curve of the lower body air cell 73c, for example. FIG. 9 illustrates air-supply curves in cases where the position/posture of the user having a body weight of 75 kg is “SUPINE POSITION/CENTER”, “SUPINE POSITION/EDGE”, “LONG SITTING POSITION/CENTER”, and “LONG SITTING POSITION/EDGE”.

In order to separately determine position/posture of the user based on the air-supply curves, predetermined reference pressure is set during the air-supply course and time to reach the predetermined reference pressure is measured. First reference pressure Pr1 is arbitrarily selected based on the air-supply curve related to each position/posture measured in advance, and a point at which the inclination of the air-supply curve changes during the air-supply course in a case where air-supply is started from the air-exhausted state is specially selected as the first reference pressure Pr1. Pressure corresponding to the internal pressure when the air mattress is actually used is set as second reference pressure Pr2.

For example, in the curves of “SUPINE POSITION/CENTER” and “SUPINE POSITION/EDGE”, the inclination of the curve up to the first reference pressure Pr1 is different from the inclination of the curve at and after the first reference pressure Pr1. For example, in a case where the user is on the edge, the inclination is gentle up to the first reference pressure Pr1, and becomes suddenly sharp when exceeding the first reference pressure Pr1. The case where the user is on the center indicates the reverse tendency of the above. The case of the long sitting position indicates the similar tendency. In a case where the air is supplied to the air cell in an air-exhausted state, the time up to the first reference pressure Pr1 (air-supply time Ta seconds) is compared with the air-supply time (air-supply time Tb seconds) from the first reference pressure Pr1 to the second reference pressure Pr2. Accordingly, whether the position of the user is on the center or edge of the mattress can be determined. For example, whether the position of the user is on the center or edge of the mattress can be determined based on a change in the inclination of the air-supply curve.

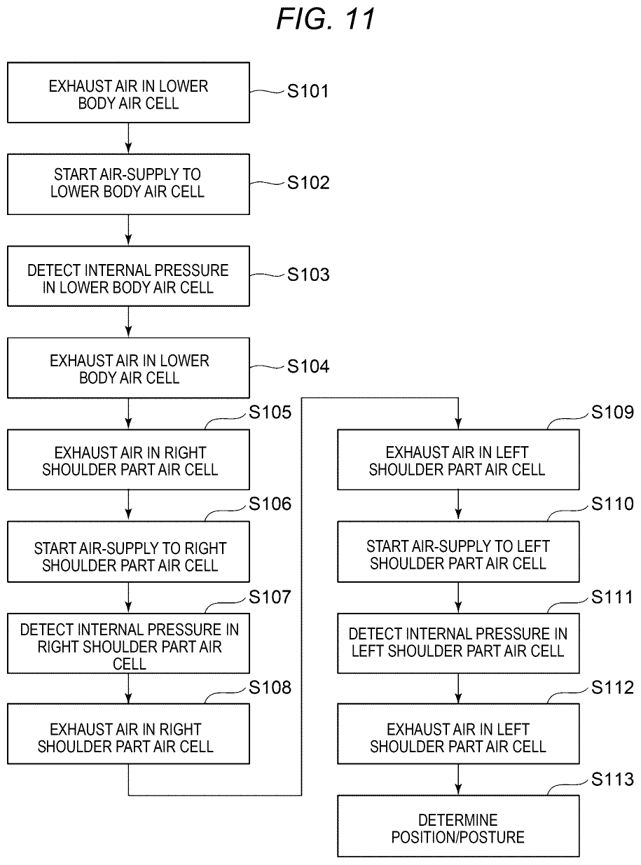

FIG. 10 is a graph illustrating an example of air-supply time.

FIG. 10 is a graph in which the abovementioned air-supply time Ta and air-supply time Tb are plotted. Regions in which data is plotted are divided between cases where the position of the user is on the center of the mattress (sleep position center) and on the edge of the mattress (sleep position edge). The position of the user can be determined based on to which region the data is plotted.

The mattress controller 83 may determine position/posture of the user, in addition to the comparison of the detection air-supply time described related to FIG. 7, based on the air-exhaust time as described related to FIG. 8 and the air-supply curves as described related to FIG. 9 and FIG. 10. Accordingly, the determination accuracy of position/posture can be improved.

In other words, whether the position of the user is on the center or edge is determined based on the air-supply curves (see FIG. 9 and FIG. 10), for example. The supine position is determined, for example, in a case where the air-exhaust time (see FIG. 8) is longer than a threshold (value that is determined based on whether the user is on the center or edge), and the left-right difference (see FIG. 7) is small. The long sitting position or edge sitting position is determined, for example, in a case where the air-exhaust time (see FIG. 8) is shorter than a threshold (value that is determined based on whether the user is on the center or edge), and the left-right difference (see FIG. 7) is large.

FIG. 11 is a flowchart illustrating an example of determination of position/posture by a mattress controller.

The mattress controller 83 exhausts the air in the lower body air cell 73c with the exhaust valve (step S101). Thereafter, the mattress controller 83 controls the solenoid valve and the air blowing section 81 to start air-supply to the lower body air cell 73c in an air-exhausted state (step S102). The mattress controller 83 detects internal pressure in the lower body air cell 73c during the air-supply (step S103). Accordingly, the mattress controller 83 acquires a detection air-supply time until the internal pressure in the lower body air cell 73c reaches a predetermined value. The mattress controller 83 then exhausts the air in the lower body air cell 73c (step S104).

The mattress controller 83 exhausts the air in the right shoulder part air cell 72b with the exhaust valve (step S105). Thereafter, the mattress controller 83 controls the solenoid valve and the air blowing section 81 to start air-supply to the right shoulder part air cell 72b in an air-exhausted state (step S106). The mattress controller 83 detects internal pressure in the right shoulder part air cell 72b during the air-supply (step S107). Accordingly, the mattress controller 83 acquires a detection air-supply time until the internal pressure in the right shoulder part air cell 72b reaches a predetermined value. The mattress controller 83 then exhausts the air in the right shoulder part air cell 72b (step S108).

The mattress controller 83 exhausts the air in the left shoulder part air cell 72a with the exhaust valve (step S109). Thereafter, the mattress controller 83 controls the solenoid valve and the air blowing section 81 to start air-supply to the left shoulder part air cell 72a in an air-exhausted state (step S110). The mattress controller 83 detects internal pressure in the left shoulder part air cell 72a during the air-supply (step S111). Accordingly, the mattress controller 83 acquires a detection air-supply time until the internal pressure in the left shoulder part air cell 72a reaches a predetermined value. The mattress controller 83 then exhausts the air in the left shoulder part air cell 72a (step S112).

The mattress controller 83 compares values obtained by normalizing the detection air-supply time of the lower body air cell 73c, the left shoulder part air cell 72a, and the right shoulder part air cell 72b. Accordingly, the mattress controller 83 determines position/posture of the user on the mattress when executing the determination control (step S113). The order of the air cells to and from which the air is supplied and exhausted is not limited to that in the example of FIG. 11, but may be switched as appropriate.

The mattress controller 83 may execute the determination control of position/posture at arbitrary timing, or may execute in a periodic basis (for example, for every 15 to 30 minutes).

The embodiment may include the following configurations.

### Configuration 1

An air mattress including:
a plurality of air cells; and
a controller configured to control an operation of an air blowing section configured to supply air to the plurality of air cells, the controller being configured to control internal pressure in the plurality of air cells, in which
the controller is configured to determine position/posture of a user based on a detection value corresponding to a speed of the change in the internal pressure in the air cells when the controller changes the internal pressure in the air cells.

### Configuration 2

The air mattress according to the configuration 1, including:
a plurality of air cells; and
a controller configured to control an operation of an air blowing section configured to supply air to the plurality of air cells, the controller being configured to control internal pressure in the plurality of air cells, in which
the plurality of air cells includes
   a first air cell, and
   a second air cell that is arranged with the first air cell in a first direction intersecting with an up-and-down direction, an air supply/exhaust system for the second air cell being different from that for the first air cell, and
the controller is configured to determine position/posture of a user based on a comparison between (i) a first detection value corresponding to a speed of the change in the internal pressure in the first air cell when the controller changes internal pressure in the first air cell and (ii) a second detection value corresponding to a speed of the change in the internal pressure in the second air cell when the controller changes internal pressure in the second air cell.

### Configuration 3

The air mattress according to the configuration 2, in which
the plurality of air cells includes a third air cell that is arranged with at least either of the first air cell and the second air cell in a second direction intersecting with each of the up-and-down direction and the first direction, an air supply/exhaust system for the third air cell being different from those for the first air cell and the second air cell, and
the controller is configured to determine the position/posture of the user based on a comparison between (i) a third detection value corresponding to a speed of the change in the internal pressure in the third air cell when the controller changes internal pressure in the third air cell and (ii) the first detection value.

### Configuration 4

The air mattress according to the configuration 2 or 3, in which
the first detection value is based on time from when air-supply is started to the first air cell in an air-exhausted state to when the internal pressure in the first air cell reaches a first predetermined value, and
the second detection value is based on time from when air-supply is started to the second air cell in an air-exhausted state to when the internal pressure in the second air cell reaches a second predetermined value.

### Configuration 5

The air mattress according to the configuration 3, in which the controller is configured to determine whether the user is in a supine position or a long sitting position, based on a difference between the first detection value and the second detection value, and a difference between the first detection value and the third detection value.

### Configuration 6

The air mattress according to any one of the configurations 1 to 5, in which the controller is configured to determine the position/posture of the user based on time during when internal pressure in the air cell decreases from first predetermined pressure to second predetermined pressure, in the air-exhaust of the air cell.

### Configuration 7

The air mattress according to any one of the configurations 1 to 6, in which the controller is configured to determine a position of the user based on an air-supply curve indicating a time change in the internal pressure in the air cell when the controller supplies the air to the air cell.

### Configuration 8

The air mattress according to any one of the configurations 1 to 7, further including:
a main mattress including a plurality of main air cells, in which
the plurality of air cells is disposed above or below the main mattress.

### Configuration 9

The air mattress according to the configuration 8, in which the controller is configured to control internal pressure in the main mattress in accordance with a determination result of the position/posture of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An air mattress comprising:
a plurality of air cells; and
a controller configured to control an operation of an air blowing section configured to supply air to the plurality of air cells, the controller being configured to control internal pressure in the plurality of air cells, wherein
the controller is configured to determine position/posture of a user based on a detection value corresponding to a speed of the change in the internal pressure in the air cells when the controller changes the internal pressure in the air cells.

2. The air mattress according to claim 1, wherein
the plurality of air cells includes
a first air cell, and
a second air cell that is arranged with the first air cell in a first direction intersecting with an up-and-down direction, an air supply/exhaust system for the second air cell being different from that for the first air cell, and
the controller is configured to determine position/posture of a user, based on a comparison between (i) a first detection value corresponding to a speed of the change in the internal pressure in the first air cell when the controller changes internal pressure in the first air cell and (ii) a second detection value corresponding to a speed of the change in the internal pressure in the second air cell when the controller changes internal pressure in the second air cell.

3. The air mattress according to claim 2, wherein
the plurality of air cells includes a third air cell that is arranged with at least either of the first air cell and the second air cell in a second direction intersecting with each of the up-and-down direction and the first direction, an air supply/exhaust system for the third air cell being different from those for the first air cell and the second air cell, and
the controller is configured to determine the position/posture of the user, based on a comparison between (i) a third detection value corresponding to a speed of the change in the internal pressure in the third air cell when the controller changes internal pressure in the third air cell and (ii) the first detection value.

4. The air mattress according to claim 2, wherein
the first detection value is based on time from when air-supply is started to the first air cell in an air-exhausted state to when the internal pressure in the first air cell reaches a first predetermined value, and
the second detection value is based on time from when air-supply is started to the second air cell in an air-exhausted state to when the internal pressure in the second air cell reaches a second predetermined value.

5. The air mattress according to claim 3, wherein the controller is configured to determine whether the user is in a supine position or a long sitting position, based on a difference between the first detection value and the second detection value, and a difference between the first detection value and the third detection value.

6. The air mattress according to claim 1, wherein the controller is configured to determine the position/posture of the user based on time during when internal pressure in the air cell decreases from first predetermined pressure to second predetermined pressure, in the air-exhaust of the air cell.

7. The air mattress according to claim 1, wherein the controller is configured to determine a position of the user based on an air-supply curve indicating a time change in the internal pressure in the air cell when the controller supplies the air to the air cell.

8. The air mattress according to claim 1, further comprising:
a main mattress including a plurality of main air cells, wherein
the plurality of air cells is disposed above or below the main mattress.

9. The air mattress according to claim 8, wherein the controller is configured to control internal pressure in the main mattress in accordance with a determination result of the position/posture of the user.
